(19) United States
(12) Patent Application Publication
(10) Pub. No.: US 2004/0167838 A1
(43) Pub. Date: Aug. 26, 2004

(54) System and method for recording negotiable instruments

(75) Inventor: Michael Pedersen, Darien, CT (US)

Correspondence Address: Arthur Dresner, Esq., Reed Smith LLP, 599 Lexington Avenue, New York, NY, 10022, US

(73) Assignee: Debt Collectors America, LLC

(21) Appl. No.: 10/374,485

(22) Filed: Feb. 26, 2003

(51) Int. Cl. G06F 17/60

(52) U.S. Cl. 705/35

(57) ABSTRACT

A system and method of putting holders of negotiable instruments on notice of a possible defect or defense and for recording descriptive information about that negotiable instrument in a location accessible to holders of the instrument. The system includes a database (11) into which descriptive information about a negotiable instrument can be registered or recorded. Such descriptive information includes details relating to a defect or defense against its payment. A maker or holder (12) records descriptive information about a negotiable instrument electronically or by direct access to the database (11) through a graphical user interface (14) over the Internet (15) storage facility by conveying (such as through the mails) details regarding the negotiable instrument to a storage facility where the information will be entered on the database by a customer service representative (18), or by telephoning (19,29) the storage facility and audibly conveying the descriptive information which is then electronically recorded in the database (11). The graphical user interface (14) contains fields into which the descriptive information may be entered. The instrument (30) created by the maker contains a notice (36), on the face of the instrument, of possible defects or defenses and a notation (37) how to access the database (11) to learn of the details of such possible defects or defenses.

### FIELD OF THE INVENTION

The present invention relates generally to the field of negotiable instruments, and more particularly to a system and method of putting holders of that instrument on notice of possible defects or defenses and of recording or registering information relating to such negotiable instruments. The recorded information can include a description of the defects and/or defenses, so that such information will be accessible to future holders. Once a holder of such instrument is on notice that there may be a defect or defense against its payment, by virtue of one aspect of the invention, that holder will be able to determine if the instrument may in fact have defects or defenses against it by means of this invention.

### BACKGROUND

There are many kinds of negotiable instruments, sometimes referred to as “money paper”. The two primary categories of money paper are (1) documents that constitute a substitution for legal tender such as “drafts” and checks; or (ii) documents that are used to represent a debt, such as promissory or negotiable notes. A “note” is a promissory instrument wherein one person (the maker) promises to pay another person (the payee) a certain amount of money. There is a primary legal distinction between “drafts” and “notes”. A draft is an order instrument in which one person (the drawer) orders a second person (the drawee) to pay money to a third person (the payee). There are several sub-categories of drafts, the most common of which is the check. The payee may receive the funds or can instruct the drawee to pay funds to the recipient of the draft, the payee, or to a subsequent holder.

Such documents are characteristically transferred among different parties in the commercial marketplace and represent an obligation of at least one party to the document to pay money. As such, rules of law governing transferability, formalities for collecting on the instrument, cashing, etc. have developed over the years in most countries throughout the world. In the United States such rules can be found in a set of laws adopted by most states, known as the Uniform Commercial Code (“UCC” or the “Code”). Common to such rules is the concept that a person who holds such documents should not be allowed to collect money from the party who has the obligation to pay the money if that holder knows or has reason to know that the document is somehow defective or that there are defenses to the payment. This concept is rooted in doctrines of good faith and fair dealing.

Central to the rules governing money paper is the concept of “negotiability.” In essence, if property is negotiable, the ownership rights of an owner may be cut off when there is a transfer of the property to a defined type of good faith purchaser. Also, when the property is intangible, the rights of the obligor to raise defenses may be extinguished as a result of certain types of transfers. Negotiability is also important in the context of documents of title, e.g., warehouse receipts and bills of lading. However, documents of title are not money paper as they represent goods, not obligations to pay money.

Among other functions, banks serve as “warehouses” for depositors' money. Unlike furniture warehouses, however, the bank does not segregate the money deposited as belonging to a particular depositor. Instead, the money is integrated, or commingled, with all funds in the bank's custody, much as fungible grain or petroleum is mixed together in storage bins or tanks. The depositor's account is credited with the amount deposited. The bank thus has a debtor/creditor relationship with the depositor: the bank owes the money to the depositor and is a debtor of the depositor. While the bank has custody of the funds, it is free to use the money for its own purposes, such as making loans to third persons at a profit. In this sense, the bank is a borrower. One of the functions that banks play in society is to accumulate money from their depositors and to invest that money.

Another important function played by banks is to act as a medium through which individuals may pay their debts. This is accomplished through the use of drafts or checks. Checks are simply drafts that are payable on demand and drawn on a bank. Thus, the bank is the drawee (sometimes called the payer) and the customer of the bank is the drawer. The check itself is a negotiable instrument and is one type of commercial paper. Basically, the bank is obligated to pay checks when drawn by its customers.

Although a bank is still a borrower of the funds deposited in a checking account, because it may invest them or use them as it sees fit, banks often charge for maintaining a checking account. There are, of course, innumerable variations to checking accounts. A certified check is different from cashiers' checks and tellers' checks, which are checks drawn by a bank on its own funds. A certified check is a check drawn by an individual on his or her account, which is certified by the payer bank. By certifying a check, which is technically an acceptance of the check, the bank becomes liable on it, and, if the certification is at the request of the payee or subsequent holder, the drawer of the check is discharged.

There are numerous other types of money paper, including money orders, traveler's checks, letters of credit, etc. A draft, if it is in the proper form prescribed by law, is a kind of negotiable instrument. The drawer orders a drawee to pay to the payee named in the draft, or to his or her order, the amount written on the face of the draft. It is a contract. The drawer promises to pay the amount of the draft if the drawee does not and if certain conditions are met or excused. This promise is implied by law. The draft is easily transferable, and if done in a certain way, it is said to be “negotiated.” For negotiation, delivery of the draft is always essential, and if payable to the order of a named person, he or she must indorse it. By signing it, an indorser also promises to pay if the drawee does not, unless he or she indicated in writing a different or contrary undertaking. Upon negotiation, the transferee is called a “holder”. If a holder has paid something for the draft and has certain qualities of innocence, he or she is a “holder in due course” who will acquire title to the instrument and the right to payment free of claims and defenses. This is an important benefit to holders of commercial paper that qualify as negotiable instruments, but it requires that the holder not be guilty of knowledge that the instrument is somehow defective or that there are defenses against its payment.

A negotiable instrument represents one or more promises to pay money. A promise has no tangible form apart from the instrument. No one can have physical possession of a promise without the instrument. Thus, a holder in due course acquires title to the instrument and “title” to the promises it contains free of claims of third persons, such as persons defrauded into negotiating it or from whom it was stolen, and free of contractual defenses the promissors might have against other promisees, such as failure of consideration.

Credit refers to a deferment of payment or, put another way, an obligation to pay in the future rather than immediately. Promissory notes, or simply “notes,” are formal IOUs that are classified as negotiable by the Code. The debtor or borrower (maker) expressly promises to pay the named creditor (payee) an amount of money in the future at the time or times indicated. The formalism gives the creditor certain legal and economic advantages he or she would not have with an informal IOU. Thus, a person who wishes to borrow money from or is already indebted to a second person may be asked or required to sign a note containing the obligation and terms of payment.

Nothing requires that a note be payable in the future, although that is the usual case. A demand note is payable immediately upon issuance, as is a demand draft, such as a check. More often than not, however, a demand note is still used as credit paper. The maker and payee informally or in another writing agree that the payee will not make demand so long as the maker performs his or her obligations, such as periodic payments of interest, principal, or both. But the payee is protected because he or she need not wait until the maker is in default and serious financial difficulty before enforcing payment. In other words, the holder can descend with a barrage of legal remedies before the maker's shaky financial house collapses. Of course, a demand note could truly be used as a payment instrument. For example, if the maker had funds in a bank, he or she could make the note payable at that bank which is the equivalent of an authorization to the bank to pay the note from available funds.

Whether it be a “note”; a “draft”; a “check” or some other type of negotiable instrument, a party who purchases or otherwise acquires possession of the instrument can collect the amount owed by the instrument and not be subject to defenses against payment if they qualify as an innocent purchaser, i.e. a holder in due course. In order to qualify as a holder in due course, a subsequent holder (someone other than the payee or drawee) must establish that they are: (1) a holder; (2) of a negotiable instruments; (3) who acquired the instrument for value; (4) in good faith; and (5) without notice of any defects or defenses against the instrument, such as a notice that it will not be honored.

In most cases whether a person qualifies as “holder” of an instrument who acquired it “for value”, and “in good faith” are straightforward issues usually easy to establish one way or the other.

The first requisite of a holder in due course is that the person be a holder. A holder is the person in possession if the instrument is payable to the bearer or, in the case of an instrument payable to an identified person, if the identified person is in possession. The first person who becomes a holder is the payee of the instrument.

Parties subsequent to the payee become holders if they are in possession of (1) bearer paper, or (2) order paper that has been properly indorsed.

Although a payee is a holder, and may be a holder in due course in some instances, a holder in due course usually takes the instrument by negotiation from the payee or a subsequent holder. For example, the payee of a check transfers it by negotiation to X, who then becomes a holder and claims the status of a holder in due course.

The second requirement for being a holder in due course is that the holder takes the instrument for “value.” Value generally means the giving of something other than a promise for the instrument, or the acquiring of a security interest in the instrument. “Good faith” is defined simply as honesty in fact in the conduct or transaction concerned. The test for good faith is a subjective one and does not include the observance of due care, acting in accord with reasonable commercial standards or an absence of negligence.

There are numerous formalities that must be satisfied for an instrument to be “negotiable” and therefore required to be honored when presented for payment by a holder. For example, the requirements prescribed by the Code in the State of New York for an instrument to be “negotiable” are that (1) it be signed by the maker or drawer; (2) contain an unconditional promise or order to pay a certain sum of money (without other promises or orders); (3) be payable on demand or at a definite time; and (4) be payable to the payee's “order” or to the instrument's bearer. If these conditions are not satisfied, then a subsequent holder of the instrument may not be able to collect on it from the maker or drawer.

The more troublesome requirement to satisfy, in order to be a holder in due course of an instrument that qualifies as “negotiable”, is that a holder did not have notice of any defect or defense.

Conceptually, the requirement that a transferee has no notice that the instrument is overdue, has been dishonored, or that there are defenses or claims to it is connected to the requirement of good faith. However, the law treats the no-notice requirement separately and in some detail. The test is primarily an objective one.

There are five separate types of notice that can destroy a transferee's potential for becoming a holder in due course:

(1) Notice that there is an ownership claim to the instrument by another person;

(2) Notice that there is a defense or claim in recoupment to it by one who would otherwise be liable as a maker, drawer, acceptor, or indorser;

(3) Notice that it is overdue;

(4) Notice of dishonor; and

(5) Notice of an unauthorized signature or alteration.

A person has “notice” of a fact when:

(1) he or she has actual knowledge of it; or

(2) he or she has received a notice or notification of it; or

(3) from all the facts and circumstances known to him or her at the time in question, he or she has reason to know that it exists.

It is this issue of “notice” to which this invention is directed. In particular, this invention relates to a system and method for providing notice to a holder so that the holder has reason to know that an instrument may not be honored, may be overdue, or there may be some other defect or defense against it, thus causing the holder to loose its status as a holder in due course.

### SUMMARY

The present invention provides both a system and method for processing a negotiable instrument to give notice of a possible defect or defense and for recording or registering descriptive information about a negotiable instrument (such as a check), including details about defects or defenses, so that future holders will be able to determine whether or not a particular negotiable instrument has any defects or defenses against it. In particular, the system of the invention includes a storage facility, which may include a database into which information about a negotiable instrument can be registered or recorded for storage and future retrieval. Such descriptive information includes information for identifying the negotiable instrument and information relating to details of a defect or defense against its payment. A maker or holder of the negotiable instrument can make use of the registration system of this invention to register for storing descriptive information about a negotiable instrument in a variety of ways. Registration can be accomplished electronically by direct access to the database through a website page having a graphical user interface, over the Internet. Alternatively, the information can be registered into the system by submitting the necessary details regarding the negotiable instrument to a receiver at the storage facility. The information will be entered into the database by the receiver. The receiver can be an automated device or system or a human customer service representative. Registration can also be accomplished by the user telephoning the storage facility and speaking via phone to a customer service representative, who will then electronically enter the information into the database using the same graphical user interface that is available via the Internet, or by using touch tone signals that are recognized by a tone receiver/converter, known as a voice response unit (“VRU”), which converts the signals to digital data that can be directly fed to the database. VRU's can also be used to convert voice signals to digital signals. Therefore, spoken responses can also be converted and fed directly to the database. As is common, the graphical user interface will contain fields into which information relating to the negotiable instrument may be entered. This will include the name of the maker or drawer, the name of the payee and the name of the drawee in cases of negotiable drafts and checks. In addition, the graphical user interface will require entry of a user ID name, password and a user account number. The graphical user interface will also have a field for entering a description of the defect or defense against the negotiable instrument, such as “a stop order has been placed on the payment of this check”. Finally, a “confirm” or “submit” button is provided for the user to click on. This will enter the data into the database.

The method of the invention involves the steps of creating a negotiable instrument, placing on its face a notation of a possible defect or defense, together with a notation about the location where the details regarding such defect or defense may be found (such as the telephone number of a storage facility, or its website address for access to the graphical user interface), and delivering that instrument to a payee. If the payee negotiates that instrument to a third party for value, the third party (a subsequent holder) will not enjoy the status of a holder in due course because he/she has received an instrument, which on its face, contains a notice of a possible defect or defense, as well as instructions as to how to verify whether or not such defect or defense exists. Further, steps of the method include the subsequent holder contacting the storage facility and making inquiry about a particular negotiable instrument, and providing certain of the identifying information so that details of a recorded defect or defense can be retrieved.

### BRIEF DESCRIPTION OF THE DRAWINGS

The invention will now be described in connection with the accompanying illustrative drawings, in which,

FIG. 1 is a schematic illustration of the system of the present invention;

FIG. 2 is an illustration of a form of draft negotiable instrument which includes an example of a notification used in the present invention;

FIG. 3 is a flow chart in block diagrammatic form illustrating certain steps of the method of the present invention;

FIGS. 4 and 5 are flow charts illustrating alternative embodiments of the method of the present invention for recording the descriptive information; and

FIGS. 6 and 7 are flow charts illustrating alternative embodiments for contacting the storage facility of the invention for retrieving details about a defect or defense.

### DESCRIPTION

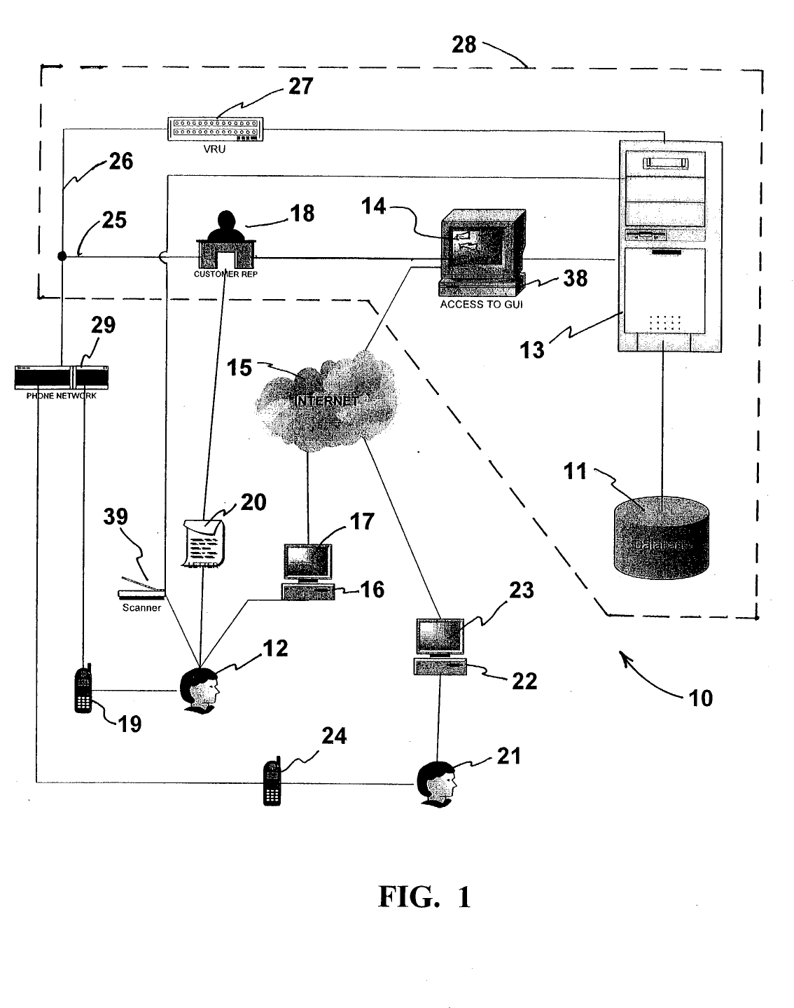

Referring first to FIG. 1, the system 10 of the invention has a service/storage facility 28 for storing certain descriptive information about a negotiable instrument. When appropriately queried, the storage facility can also provide the requester with the details about a possible defect or defense included in the stored descriptive information. The storage facility 28 can have many different types of capabilities for storing the information. In the embodiment illustrated in FIG. 1 storage and recording of the descriptive information is in a database 11 maintained at the storage facility. A maker or issuer 12 can record descriptive information regarding a negotiable instrument in the database 11. Such descriptive information can include certain identifying information such as the name of the maker, the name of the payee, the name of the drawee, a date of the instrument, and an identifying serial number. The descriptive information may also include details of any defect in the instrument or defense against payment. For example, a maker may want to record information that a particular negotiable instrument will not be honored for payment. Dishonor of payment is usually accomplished by a maker placing a stop payment order with the drawee bank. Thus, the maker can register descriptive information about the instrument (such as its serial number, date of issue, names of drawer, drawee and payee) along with a detailed notation such as, “a stop order has been placed on the payment of this check.” Once recorded or registered, the information about the defect or defense is retrievable and thus readily available to any person who can access the database 11. Such persons can include subsequent holders of that negotiable instrument, provided they are authorized to do so by the storage facility. Such authority may require the use of an ID name and/or password, or payment of a fee. Accordingly, if the negotiable instrument document itself contains an indication that information regarding possible defects or defenses is readily available in the database, then a holder of it is likely to lose his status as a “holder in due course” because he will now have reason to believe that there may be a defect or defense, and he or she has a ready mechanism to confirm such defect or defense.

A server 13 located at the storage facility 28 is connected to the database 11 for electronic communication with the database to control the flow of information to and from the database. The system further includes a website having graphical user interface (“GUI”) 14 which can be accessed with a computer. The descriptive information regarding the negotiable instrument to be registered in the database can be entered onto the graphical user interface so that such information can be stored or retrieved from database 11. The graphical user interface 14 is connected to the server as a means for entering and retrieving information to and from the database. There are a variety of way for either entering information into or for retrieving information from the database 11.

One way to record defects or defenses against a particular negotiable instrument into the database 11 is over the Internet 15. Using a client computer 16 a user 12 can access the Internet 15 so that the website of the storage facility can be found. One of the pages of the website will contain the graphical user interface 14, which will be shown on display 17. In this manner user 12 can enter identifying information regarding a negotiable instrument directly onto the graphical user interface. By clicking on a “submit” button the entered information can be electronically conveyed through the server 13 to be stored in the database 11. There are other ways that the user can also record or register the descriptive information. He or she could telephone the storage facility and provide the information regarding the negotiable instrument using a telephone 19. The facility 28 can be connected to the maker/user 12 over a traditional telephone network 29. User 12 will convey the information directly to a customer service representative 18 by phone and telephone line 25. The customer service representative will then enter the information through the graphical user interface 14 on a computer 38 maintained at the storage facility.

Alternatively the storage facility 28 is provided with an automatic device or system 27 to receive the identifying information rather than a human customer service representative. The automatic device 27 will be connected to and receive the identifying information from the user 12 over the phone line 26 and will convert the received information into digital signals which are transmitted directly through the server 13 to the database 11 for storage. One such automated device is a converter for converting touch tone audible signals from a telephone touch pad, or spoken voice audible signals, into digital signals. The converter may include computerized programs for prompting the caller to use the touch pad for entering the information, or to speak the information. Such devices, known as voice response units (“VRU”), are well known in the art and are commercially available.

Additionally, the descriptive information can be sent to the storage facility electronically, as a result of a scanner device 39 that scans the negotiable instrument and generates digital data that can be conveyed to the storage facility and fed to the server 13.

The descriptive information regarding the negotiable instrument can also be sent to the storage facility by mail 20 (regular mail or electronic) so that the customer service representative 18 will receive the information in the mail system and convey the information to the database 11 through graphical user interface 14 and server 13.

Once the descriptive information is recorded in the database 11, it is available to be retrieved by holders of that negotiable instrument. A holder of a negotiable instrument that is defective or against which there are defenses will lose its status as a holder in due course (thus being unable to collect on the negotiable instrument) if that holder accepted the negotiable instrument with notice of the defect or defense. A person who accepted a negotiable instrument that has a notation on its face that there may be such a defect or defense, is no longer an innocent purchaser.

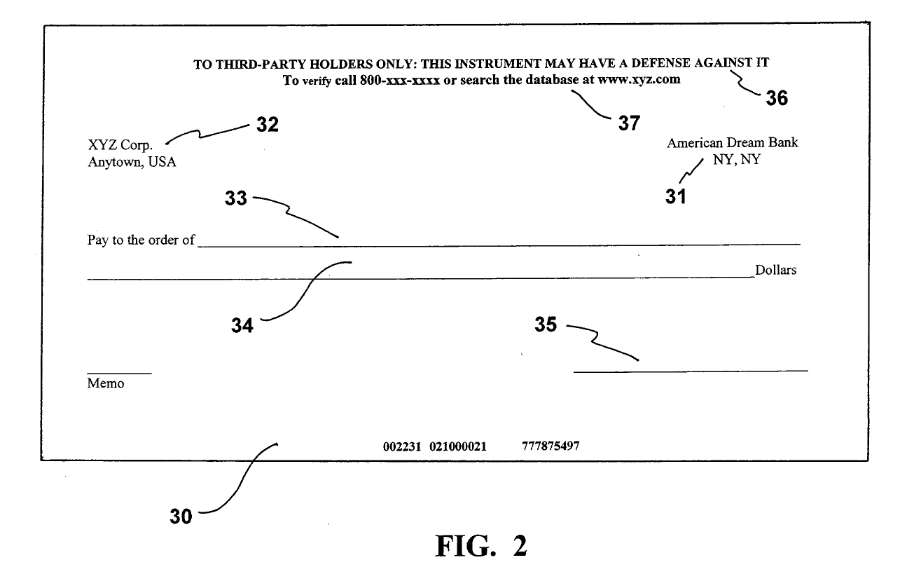

FIG. 2 illustrates an example of a negotiable instrument containing such a notation. FIG. 2. shows a negotiable instrument in the form of a draft, such as a check 30. The check 30 shows the name of the party 31 on whom it is drawn, the name of the maker 32, a place 33 to insert the name of the payee and a place 34 for the amount of the check. A place 35 is also provided for the maker's signature. A notation 36 is prominently displayed on the face of the draft in order to provide holders with notification that this particular negotiable instrument may have a defect or defense against it. In the example shown in FIG. 2 the notation is worded as follows: “TO THIRD PARTY HOLDERS ONLY: THIS INSTRUMENT MAY HAVE A DEFENSE AGAINST IT”. Instructions 37 as to how to determine whether or not such defects or defenses exist is also provided. In FIG. 2 these instructions are worded: “TO VERIFY CALL 1-800-XXX-XXXX OR SEARCH THE DATABASE AT WWW.XYZ.COM.” The telephone number will put the caller in contact with the facility 28 and, by communication with either a customer service representative 18 or a VRU 27, will be able to inquire about the negotiable instrument for which descriptive information was recorded. In this manner any descriptive information which is recorded in association with the negotiable instrument, including details of a defect or defense, will be conveyed to the caller. By contacting the noted website address, the holder will be able to open the page having the graphical user interface 14. Using this connection the holder will be able to identify the negotiable instrument in question by filling in the appropriate fields with identifying information and when clicking on a “retrieve submit” button the identifying information will be submitted to the database for a search. Any information recorded in the database concerning that negotiable instrument, including details of defects or defenses, will be retrieved. With a notice that provides instructions on how to access the database, a holder 21 can now determine whether or not a particular negotiable instrument that he may be holding is subject to a defect or defense by making inquiry to the storage facility 28 for the descriptive information recorded on the database 11.

Referring once again to FIG. 1, if a holder 21 receives a negotiable instrument with a notation, such as the one illustrated in FIG. 2, he or she will thus know that the instrument he or she is holding may have a defect or defense against it. The holder has also been provided with instructions as to how to determine with certainty whether or not such defects exist, i.e., how to contact the storage facility.

Accordingly, holder 21 can access the database 11 by telephoning, over phone 24 and network 29, the number provided on the draft, in which case he will be connected to the storage facility 28 and be put in contact with either the customer service representative 18 or the VRU 27. The holder will provide details about the instrument he or she is holding, such as some of the identifying information. A customer service representative can then use the graphical user interface 14 to retrieve the recorded information through server 13 and database 11 to determine whether or not there is in fact defenses or defects relating to that negotiable instrument. Alternatively, VRU 27 can convert the holder 21 request into digital signals to directly retrieve the information from database 11 through server 13. The holder 21 can also use his computer 22 to access the Internet 15, which will provide him direct access to the website of the storage facility 28. The holder can then display the graphical user interface 14 on his display screen 23. Holder 21 can thus directly access database 11 by providing the proper identifying information on the requested fields and submitting that information to the server 13. The graphical user interface will also contain a “retrieve submit” or “verify” button which will call up all the descriptive information about the requested negotiable instrument. In this manner, the holder 21 can view the recorded descriptive information regarding the negotiable instrument he or she is holding and determine with certain knowledge as to whether or not a defect or defense exists.

The storage facility can charge a fee to either or both of the persons recording descriptive information or requesting retrieval of stored recorded information. This can be done either on a subscription basis (by providing an account number) or on a per use basis (by providing a credit card).

Because the holder 21 has been put on notice of a possible defect or defense against the negotiable instrument, by virtue of the notice printed on the instrument itself, that holder will loose his/her status as a holder in due course and will be subject to the defenses.

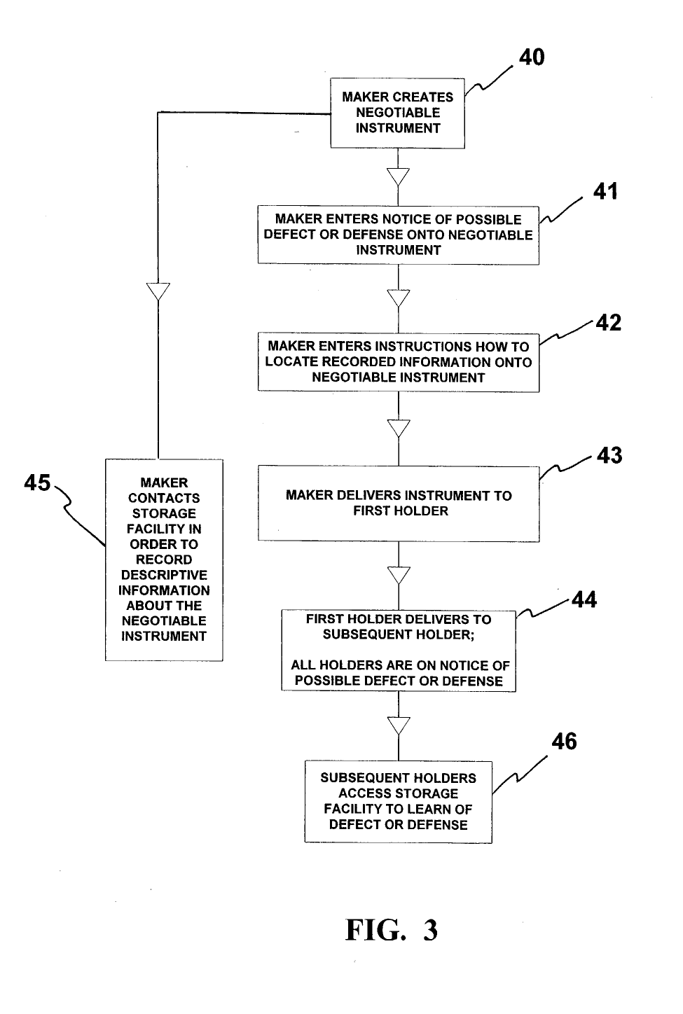

As illustrated in FIG. 3, the method of the invention includes the making of a negotiable instrument 40, entering at step 41 a notation onto the face of the instrument, in a noticeable location, that the instrument is subject to a possible defect or defense, entering at step 42 instructions on how to contact the storage facility in order to retrieve the stored recorded descriptive information, and delivering that instrument to a payee (the first holder) at step 43. If the payee negotiates that instrument to a third party for value (step 44), the third party (a subsequent holder) will not enjoy the status of being a holder in due course because he/she has received an instrument, which on its face, contains a notice of a possible defect or defense as well as instructions as to how to verify whether or not such defects or defenses exist.

The method includes the further step 45 of the maker contacting a recording facility, such as storage facility 28, for the purpose of recording the descriptive information, including details regarding defects or defenses in a location accessible to possible subsequent holders. This location could be a database, such as database 11.

A subsequent holder can also access, at step 46, the storage facility 28 with database 11 to retrieve and learn of the possible defects or defenses.

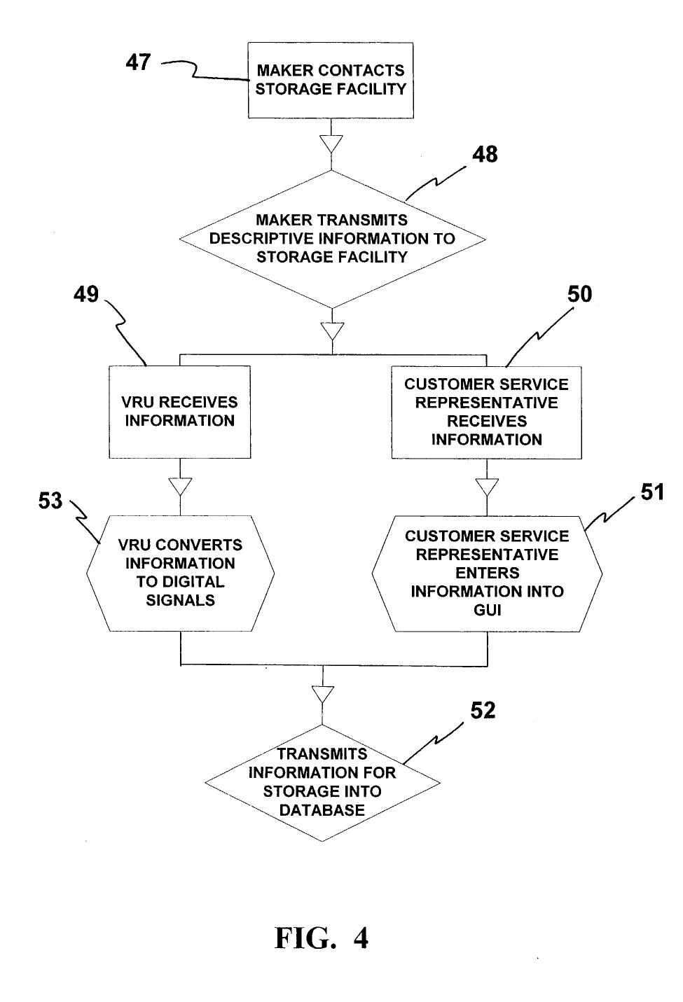

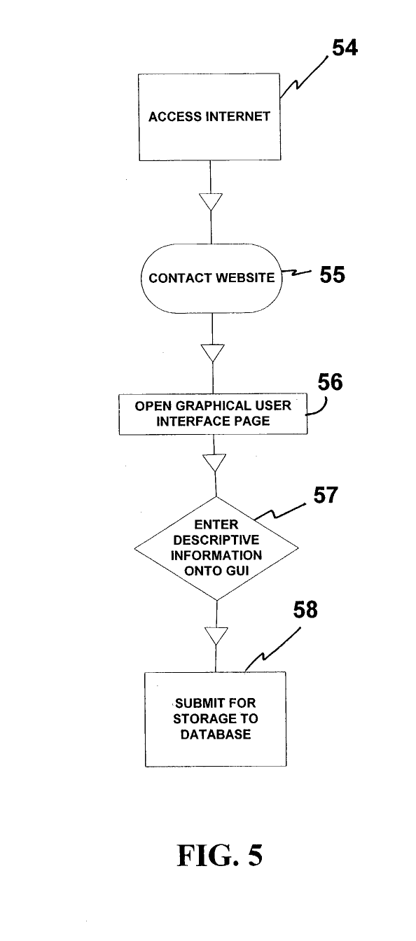

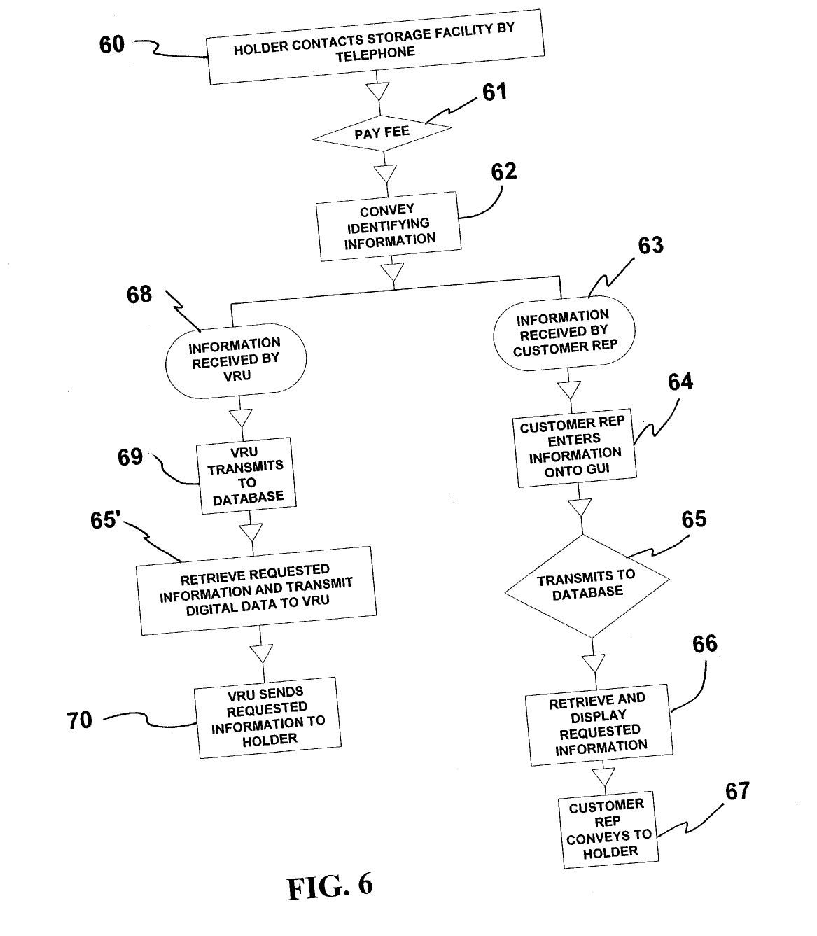

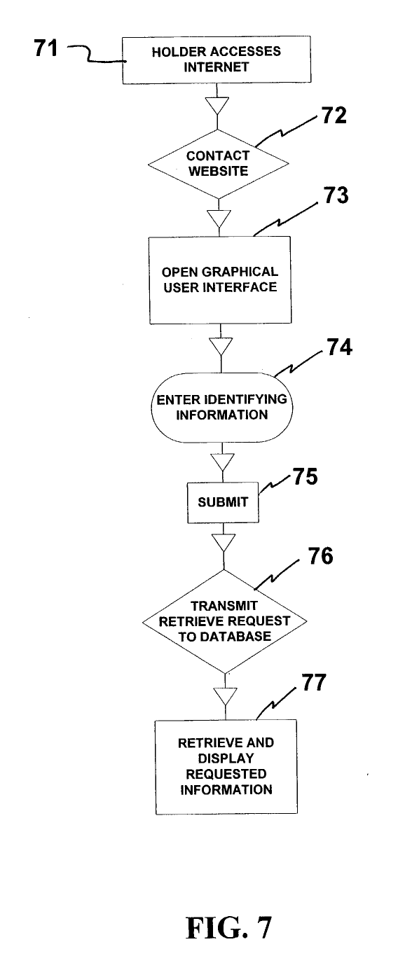

FIGS. 4 and 5 demonstrate alternative steps for recording the descriptive information into the database 11. FIGS. 6 and 7 demonstrate alternative steps for contacting the storage facility and retrieving the details of the possible defects or defenses.

Referring first to FIG. 4, at step 47 the maker contacts the storage facility 28 (at which time he may be required to pay a fee) and conveys at step 48 the descriptive information regarding the negotiable instrument. This can be achieved over traditional telephone lines so that it is received either by the VRU at step 49 or alternatively is received by a customer service representative at step 50. If it is received by the customer service representative, that customer service representative will then enter the appropriate descriptive information at 51 onto fields of the graphical user interface. The customer service representative will then select the “submit” button at 52 to transmit the entered descriptive information for storage through the server 13 into database 11. If alternatively the descriptive information is received by the VRU, this device will convert at 53 the tone or spoken audible signals into digital signals which is then transmitted at step 52 for storage in the database.

FIG. 5 demonstrates an alternative technique for recording the descriptive information in database 11. A step 54 the user will access the Internet using a computer. At step 55, the user contacts the website of the storage facility. At step 56, the graphical user interface page is opened. At this point, step 57, the maker will enter the descriptive information into the appropriate fields on the graphical user interface and at step 58 will submit that information to the database for storage and later retrieval.

FIG. 6 illustrates the manner in which a subsequent holder can contact the storage facility 28 to make an inquiry about a negotiable instrument which has been recorded. At step 60 the holder contacts the storage facility via telephone and may be charged a fee at 61. At step 62 certain identifying information relating to a particular negotiable instrument is conveyed to the storage facility. At step 63 the customer service representative will receive the information and enter it into the graphical user interface at step 64. This information will be transmitted at step 65 to the database. The descriptive information is then retrieved at 66 and displayed on computer 38 for the customer service representative to convey it to the holder at step 67. The identifying information may alternatively be received by the VRU at 68. The VRU will convert the conveyed information into digital signals and transmit it at step 65′ to the database. The database will then retrieve the requested information and convey it at 69 in the form of digital signals to the VRU, which will convert the information into audible spoken signals and relay by telephone at 70 to the holder.

A holder may also use the Internet to retrieve the defect or defense information from the database. In the embodiment illustrated in FIG. 7 the holder at step 71 will use his computer to access the Internet. At step 72 the holder will contact the website address of the storage facility, and at step 73 will open the page having the graphical user interface. At step 74 the holder will enter certain identifying information about the negotiable instrument into the appropriate fields on the graphical user interface and then will submit this information at step 75 so that it can be transmitted to the database at step 76 with a request to retrieve the details about any defects or defenses. The details will then be retrieved and displayed at the website at step 77 so that the holder can view them.

The invention has been described and illustrated in connection with certain preferred embodiments, which illustrate the principals of the invention. However, it should be understood that various modifications and changes may readily occur to those skilled in the art, and it is not intended to limit the invention to the construction and operation of the embodiments shown and described herein. Accordingly, additional modifications and equivalents may be considered as falling within the scope of the invention as defined by the claims herein below.

What is claimed is:

1. A method of placing holders of negotiable instruments on notice of a possible defect or defense against the payment of said negotiable instrument, comprising: creating a negotiable instrument, placing a written notification on said negotiable instrument that the within instrument may be subject to a defect or defense against payment thereof, placing address information on said negotiable instrument indicating where to verify whether such defects or defenses exist, and delivering said negotiable instrument to a first holder thereof so that said holder and all subsequent holders thereof are on notice as to said possible defect or defense.

2. The method according to claim 1 wherein said written notification is placed in a prominent and noticeable location on the face of said negotiable instrument.

3. The method according to claim 2 wherein said address information is placed in a prominent and noticeable location on the face of the said negotiable instrument.

4. The method according to claim 3 comprising the further step of negotiating the transfer of said negotiable instrument by said first holder to a subsequent holder.

5. The method according to claim 4 wherein said notification states that said negotiable instrument may have a defense against it.

6. The method according to claim 4 wherein said notification states that said negotiable instrument may have a defect.

7. The method according to claim 4 wherein said notification states that said negotiable instrument may have a defect or defense against it.

8. The method according to claim 4 wherein said address information includes a telephone number.

9. The method according to claim 4 wherein said address information includes a website address.

10. The method according to claim 4 further comprising recording descriptive information about said negotiable instrument in a storage location accessible to holders of said instrument.

11. The method according to claim 10 wherein said descriptive information includes identifying information sufficient to identify said negotiable instrument.

12. The method according to claim 11 wherein said identifying information includes the name of the maker.

13. The method according to claim 11 wherein said identifying information includes the name of the payee.

14. The method according to claim 11 wherein said identifying information includes a document number identifier.

15. The method according to claim 11 wherein said descriptive information includes details regarding said defect or defense.

16. The method according to claim 15 wherein said storage location is an information storage facility.

17. The method according to claim 16 wherein recording said descriptive information comprises contacting said storage facility and conveying said descriptive information to a receiver of said descriptive information.

18. The method according to claim 16 wherein said receiver transmits said descriptive information for recording in a retrievable form.

19. The method according to claim 18 wherein said retrievable form is an electronic database.

20. The method according to claim 19 wherein said receiver is an automated device.

21. The method according to claim 20 wherein said automated device is a voice response unit.

22. The method according to claim 19 wherein said receiver is a human being.

23. The method according to claim 19 wherein said receiver is a graphical user interface accessible on a page of a website address.

24. The method according to claim 18 wherein said step of conveying comprises transmitting said descriptive information telephonically.

25. The method according to claim 24 wherein said step of conveying comprises transmitting said descriptive information electronically.

26. The method according to claim 18 wherein said step of conveying comprises transmitting said descriptive information through a mail system.

27. The method according to claim 26 wherein said mail system is an electronic mail system.

28. The method according to claim 18 wherein said step of conveying comprises transmitting said identifying information over the Internet.

29. The method according to claim 28 wherein the step of conveying said identifying information over the Internet comprises accessing the website of said storage facility, opening a page of said website containing a graphical user interface, entering said identifying information into predetermined fields on said graphical user interface, and clicking a submit button so that said entered identifying information is electronically transmitted for recording in a retrievable form.

30. The method according to claim 18 further comprising the step of paying a fee upon conveying said descriptive information for recording.

31. The method according to claim 18 further comprising the step of contacting said storage facility for retrieving said details regarding said defect or defense.

32. The method according to claim 31 wherein the step of contacting said storage facility for retrieving said details regarding said defect or defense comprises telephoning the telephone number of said storage facility and conveying to said storage facility certain of said identifying information to be used for identifying said negotiable instrument so that the descriptive information thereof can be retrieved from recorded storage.

33. The method according to claim 31 wherein the step of contacting said storage facility for retrieving said details regarding said defect or defense comprises accessing the website of said storage facility over the Internet.

34. The method according to claim 33 further comprising opening a page of said website containing a graphical user interface, entering into predetermined fields on said graphical user interface certain of said identifying information sufficient to identify said negotiable instrument, and clicking a retrieve button so that submitting said identifying information will result in retrieving details about said defects or defenses.

35. The method according to claim 31 further comprising the step of paying a fee upon submitting a request for retrieving said details regarding said defect or defense.

36. A method of placing holders of negotiable instruments on notice of a possible defect or defense against the payment of said negotiable instrument, comprising: creating a negotiable instrument, placing a written notice in a prominent and noticeable location on the face of said negotiable instrument to indicate that the within instrument may be subject to a defect or defense against payment thereof, placing address information comprising a telephone number and a website address in a prominent and noticeable location on the face of the said negotiable instrument indicating where to verify whether such defect or defense exists, delivering said negotiable instrument to a first holder thereof so that said holder and all subsequent holders thereof are on notice as to said possible defect or defense, negotiating the transfer of said negotiable instrument by said first holder to a subsequent holder, contacting an information storage facility, conveying descriptive information about said negotiable instrument to a receiver of said descriptive information, said descriptive information including identifying information and details about said defect or defense, transmitting by said receiver said descriptive information for recording in a retrievable electronic database, and contacting said storage facility for retrieving said details regarding said defect or defense.

37. The method of claim 36 wherein said step of conveying comprises scanning said negotiable instrument and generating electronic signals from said scan, and electronically transmitting said signals to said receiver.

38. The method of claim 36 wherein said receiver is a voice response unit, said step of conveying comprising transmitting said descriptive information to said voice response unit telephonically, said voice response unit transmitting said descriptive information to said database for retrievable recording therein in the form of digital signals.

39. The method of claim 36 wherein said step of conveying comprises accessing over the Internet said website address of said storage facility, opening a page of said website containing a graphical user interface, entering said descriptive information into predetermined fields on said graphical user interface, and clicking a submit button so that said entered descriptive information is electronically transmitted for recording in said database.

40. The method of claim 36 further comprising the step of paying a fee for recording said descriptive information.

41. The method of claim 36 wherein said step of contacting said storage facility for retrieving said details regarding said defect or defense comprises telephoning said telephone number of said storage facility and providing to said receiver certain of said identifying information to be used for identifying said negotiable instrument so that the descriptive information can be retrieved from said database.

42. The method of claim 36 wherein the step of contacting said storage facility for retrieving said details regarding said defect or defense comprises accessing said website of said storage facility over the Internet, opening a page of said website containing a graphical user interface, entering into predetermined fields on said graphical user interface certain of said identifying information sufficient to identify said negotiable instrument, and clicking a retrieve button so that submitting said identifying information will result in retrieving details about said defects or defenses.

43. The method of claim 36 further comprising the step of paying a fee for retrieving said details regarding said defect or defense.

44. A method of processing a negotiable instrument comprising: receiving by a holder a negotiable instrument bearing a notice that contains contact information for contacting a destination from which the holder may uncover a potential defect or defense against payment of said instrument; contacting the destination by the holder; providing identifying data of the received negotiable instrument by the holder sufficient for the destination to retrieve information regarding the potential defect or defense against the received negotiable instrument; requesting the destination to provide said defect or defense information; and receiving by the holder the result of said request.

45. The method of claim 44 wherein said notice is prominently located on the face of said negotiable instrument so as to be readily observable.

46. The method of claim 45 wherein said notice indicates that the negotiable instrument contains a defect or is subject to a defense against payment.

47. The method of claim 46 wherein said notice further comprises a telephone number or website address of said destination.

48. The method of claim 47 wherein the step of receiving said negotiable instrument by said holder occurs when said holder receives said instrument from the payee thereof.

49. The method of claim 48 further comprising the step of recording descriptive information about said negotiable instrument at said destination.

50. The method of claim 49 wherein said descriptive information includes identifying information and details regarding said defect or defense.

51. The method of claim 50 wherein said identifying information includes the name of the maker.

52. The method of claim 50 wherein said identifying information includes the name of the payee.

53. The method of claim 50 wherein said identifying information includes the date of said negotiable instrument.

54. The method of claim 50 wherein said identifying information includes a document number identifier.

55. The method of claim 50 wherein recording said identifying information comprises contacting said destination, and conveying said descriptive information to a receiver of said descriptive information.

56. The method of claim 55 wherein said receiver records said descriptive information in a retrievable electronic database.

57. The method of claim 56 wherein the step of conveying said descriptive information to said destination comprises accessing over the Internet the website of said destination, opening a page of said website containing a graphical user interface, entering said descriptive information into predetermined fields on said graphical user interface, and clicking a submit button so that said entered descriptive information is electronically submitted to said database for retrievable storage therein.

58. The method of claim 56 wherein the step of conveying said descriptive information comprises transmitting said descriptive information telephonically to said destination.

59. The method of claim 56 further comprising the step of paying a fee to said destination for recording said identifying information.

60. The method of claim 56 wherein the step of requesting the destination to provide said defect or defense information comprises accessing over the Internet the website of said destination, opening a page of said website containing a graphical user interface, entering said identifying information into predetermined fields on said graphical user interface, and clicking a retrieve submit button so that said entered identifying information is electronically submitted to said database for locating and retrieving said details about said defect or defense.

61. The method of claim 56 wherein the step of requesting the destination to provide said defect or defense information comprises transmitting said identifying information telephonically to said destination , and telephonically requesting said information.

62. The method of claim 56 further comprising the step of paying a fee for requesting said destination to provide said defect or defense information.

63. A system for putting a holder of a negotiable instrument on notice of a possible defect or defense against the payment thereof and for recording descriptive information about said negotiable instrument in an accessible location, said descriptive information including details about said possible defect or defense, comprising: said instrument bearing on the face thereof a notation that said instrument may be defective or subject to a defense against its payment and contact information for verifying if said instrument is defective or has a defense, a storage facility for retrievably storing said descriptive information, means for contacting said storage facility for recording said descriptive information, and means for contacting said storage facility for retrieving said descriptive information.

64. The system according to claim 63 wherein said descriptive information includes information for identifying said negotiable instrument and details regarding said defect or defense.

65. The system according the claim 64 wherein said identifying information includes as least the name of the maker and the name of the payee thereof.

66. The system according to claim 63 wherein said storage facility includes a database for electronically storing said descriptive information.

67. The system according to claim 66 further comprising a server connected to said database for controlling the flow of information to and from said database.

68. The system according to claim 66 wherein said means for contacting said storage facility comprises a computer capable of accessing graphical user interface for entering information in predetermined fields on said graphical user interface so that said descriptive information may be conveyed to said database.

69. The system according to claim 66 wherein said storage facility includes a voice response unit for receiving audible signals and converting said audible signals into digital signals to be conveyed to and from said database.

70. The system according to claim 69 wherein said means for contacting said storage facility comprises a telephone system connected to said voice response unit for providing audible signals thereto.

71. The system according to claim 66 wherein said means for contacting said storage facility comprises an electronic transmitter connected to said receiver for transmitting electronic signals generated by scanning said negotiable instrument.

72. A system for processing a negotiable instrument bearing a notice that said negotiable instrument may be defective or subject to a defense against payment comprising: a database for electronically retrievably storing descriptive information about said negotiable instrument, said descriptive information including details about said possible defect or defense and identifying information sufficient for identifying said instrument and locating said details when stored in said database, a server connected to said database for controlling the flow of information to and from said database, electronic means connected to said server for inputting said descriptive information for recording in said database, and electronic means connected to said server for retrieving said descriptive information by inputting said identifying information.

73. The system according to claim 72 wherein said electronic means for inputting comprises a computer capable of accessing a website page containing a graphical user interface over the Internet.

74. The system according to claim 72 wherein said electronic means for retrieving comprises a computer capable of accessing a website page containing a graphical user interface over the Internet.

75. The system according to claim 72 wherein said electronic means for inputting comprises a voice response unit.

76. The system according to claim 72 wherein said electronic means for retrieving comprises a voice response unit.
